(19) United States
(12) Patent Application Publication
(10) Pub. No.: US 2011/0022262 A1
(43) Pub. Date: Jan. 27, 2011

(54) MOTOR VEHICLE ENERGY-SAVING ASSISTANCE SYSTEM

(75) Inventors: Helmut Fennel, Bad Soden (DE); Christian Meise, Eschborn (DE)

Correspondence Address: RATNERPRESTIA, P.O. BOX 980, VALLEY FORGE, PA, 19482, US

(73) Assignee: CONTINENTAL TEVES AG & CO. OHG, Frankfurt (DE)

(21) Appl. No.: 12/742,775

(22) PCT Filed: Nov. 14, 2008
(86) PCT No.: PCT/EP2008/065528

§ 371 Date: Sep. 23, 2010

(30) Foreign Application Priority Data
Nov. 16, 2007 (DE) 10 2007 054 738.4

(51) Int. Cl. G06F 7/00; G06F 13/40

(52) U.S. Cl. 701/33; 710/305

(57) ABSTRACT

A motor vehicle energy-saving assistance system which helps to save energy and optimize emissions. An electronic device may be permanently installed in the vehicle, or a portable computer containing an energy-saving program may be used. The device or program exchanges data with several vehicle control devices. The vehicle control devices carry out specific driver-assist or vehicle functions and the further data channel provides a connection between the device or the portable computer and the vehicle control device(s). At least one unidirectional wireless, inductive or capacitive data transmission is enabled. A driver display device is controlled by the energy-saving program and the energy-saving program determines the actual condition of the vehicle and the estimated future condition in order to calculate the energy-saving measure(s). A motor vehicle equipped with an interface which provides access to the vehicle onboard bus system is also described.

### CROSS REFERENCE TO RELATED APPLICATIONS

This application is the U.S. National phase application of PCT International Phase Application No. PCT/EP2008/065528, filed Nov. 14, 2008, which claims priority to German Patent Application No. 10 2007 054 738.4, filed Nov. 16, 2007, the contents of such applications being incorporated by reference herein.

### FIELD OF THE INVENTION

The invention relates to a motor vehicle energy-saving assistance system which assists the driver in saving energy or in optimizing emissions.

### BACKGROUND OF THE INVENTION

The prior art discloses providing a vehicle driver with instructions which give the driver assistance in driving economically, indicating, for example, to what extent he should accelerate or which gear he should engage. Devices for displaying the instantaneous fuel consumption or so-called economy displays are also extremely widespread.

DE 199 01 532 A1, which is incorporated by reference, describes a method for diagnosing the causes of increased fuel consumption. To do this, the actual mileage or kilometerage is compared with the theoretical mileage or kilometerage. If there is found to be a difference between these variables, this may be due to the technical state of the vehicle and the driving behavior of the driver as well as external influences (air resistance, rolling resistance, route profile). The described method essentially pursues here the objective of detecting a defect in the vehicle. The vehicle and the behavior of the driver are not influenced here.

EP 0 906 845, which is incorporated by reference, discloses a device with which, in a motor vehicle, a pressure point for the accelerator pedal which can be sensed by the driver's foot is defined as a function of the driving state. The driver can then decide whether to pass beyond the predefined pressure point (“kick-down” function).

### SUMMARY OF THE INVENTION

An object of the present invention is to lower the energy consumption of motor vehicles with a device which assists the driver by means of a comprehensive approach and/or to optimize the emissions (gases, noise) thereof.

This object is achieved by means of the motor vehicle energy-saving assistance system as discussed herein.

The motor vehicle energy-saving assistance system according to aspects of the invention assists the driver in saving energy, and assists the driver in optimizing the emission values of the vehicle (for example exhaust gases and also noise).

For this purpose, an electronic device which is permanently installed in the vehicle or a mobile computer contains an energy-saving algorithm, and said device or said computer exchanges data, over a further data channel, with a plurality of electronic vehicle control units which communicate over at least one data bus.

The vehicle control units usually carry out specific driver assistance or vehicle functions (for example ESP and ABS brake control). The further data channel makes available a connection between the device or the mobile computer and the vehicle control unit or units.

The transmission over the further data channel takes place via an at least unidirectional data link which is in particular wireless or non-wireless, such as for example via an inductive or capacitive connection.

The vehicle control units which are arranged in the vehicle preferably communicate with one another via a CAN data bus and/or a FlexRay® data bus.

In order to influence the vehicle in any way, at least one driver display device is actuated by the energy-saving algorithm, wherein, in order to establish the energy-saving measure or measures, the energy-saving algorithm determines the current state of the vehicle and the expected future state thereof.

The system can preferably be operated or configured as an active or passive variant. In the passive variant, the system merely proposes, to the vehicle driver, specific measures for driving in a way which is optimized in terms of energy and spares the environment, or for optimizing emissions. In the active variant, interventions are also made into the vehicle, which influence the travel of the vehicle and/or its operator control elements (for example accelerator pedal, brake pedal, clutch, steering wheel, gearshift system). The system is particularly preferably configured in such a way that the active variant is combined with the passive variant. An advantageous possibility of use of the active variant is found in particular in the permanently installed variant of the energy-saving system according to aspects of the invention, since integration into the vehicle communication network can be performed particularly easily.

As already described above, the motor vehicle energy-saving assistance system according to the aspects of the invention comprises an electronic device which is permanently installed in the vehicle or a mobile computer containing an energy-saving algorithm. The device or the mobile computer, which is preferably embodied as a PDA or mobile telephone, preferably communicates with the electronic vehicle control unit or units over an additional data channel or data bus (for example a wire or radio link). The device can expediently either be permanently installed in an electronic vehicle control unit (for example on-board computer, gateway, navigation system, MMI, etc.) in an integrated fashion or can be permanently installed in the vehicle as an additional control unit, or can be arranged independently of the vehicle, that is say in a mobile computer (for example PDA, navigation system, etc.). Corresponding device combinations are also conceivable.

The evaluation and processing of the vehicle data which are relevant for the energy-saving algorithm and which can be exchanged over the data bus mentioned above is carried out by means of the energy-saving algorithm. The latter can not only read out the relevant vehicle data but preferably also transmit control commands to the vehicle over the further data channel. The energy-saving algorithm can in this way access a plurality of vehicle data items which are available in real time on the data bus. The energy-saving algorithm preferably determines from the vehicle data what driving state (working point) the vehicle is in at that time and also calculates, in particular, the future driving state using further vehicle data. In this context, position information and/or map information are particularly preferably also processed.

If the energy-saving algorithm has calculated a driving strategy, this can either be conveyed to the driver, so that the driver implements the driving strategy entirely or partially by means of his driving style, or the energy-saving algorithm automatically influences or controls the vehicle by intervention in the operator control elements of the vehicle. As a result, a predictive driving style can be assisted and the energy consumption can be reduced. For example, the data of an adaptive cruise control system are particularly important here. The mode of automatic intervention (energy-saving measure) is preferably implemented in such a way that it can be switched on optionally. The driver can then choose, in particular, whether or not he wishes to save energy in the automatic mode. It is particularly expedient if the algorithm at the same time also provides a mode which only makes proposals to the driver as to how he is to behave.

As already mentioned above, the system preferably evaluates, by means of a conventional satellite-supported determination of position (for example GPS) using cartographic data, route profiles, in particular the route and altitude profile, of the route which is desired by the driver in order to save energy. In this way it is possible to provide strategic recommendations with respect to the driving style over a relatively long time period as a dynamically modified sequence of measures. That is to say the algorithm particularly preferably takes measures or provides recommendations which not only take into account traffic events but also past and future measures/recommendations in a current measure. For example, the optimum speed and the acceleration/deceleration profile can be predefined predictively over a relatively long time period.

In the active variant, described above, of the system according to aspects of the invention, intervention is preferably made into the engine control unit and/or brake control unit. In particular, interventions which prevent unadapted acceleration at an insufficient distance from the vehicle traveling ahead are made here into the engine management system.

According to a further preferred embodiment, “vehicle-to-vehicle” communication is also included in the energy-saving algorithm. With the data from a “vehicle-to-vehicle” communication it is possible, for example, for particularly economical braking maneuvers and acceleration maneuvers to be predefined by the system by means of the vehicle distances in backed up traffic on freeways.

Furthermore, the invention also relates to a vehicle that permits active influencing of the vehicle through devices which are independent of the vehicle (“nomadic devices”) via an interface. However, a safety device, which prevents unauthorized use of the interface, must preferably be present here. The interface can expediently be implemented by means of a radio link, in particular WLAN radio link, such as, for example Bluetooth®.

The safety devices which are intended to prevent misuse are preferably also suitable for preventing a malfunction due to faults. The safety device can expediently be encoded with a keyless entry system such as, for example, an encoded, wireless vehicle door opener (“radio ignition key”), so that an encrypted and authenticated data link is made available.

It is particularly expedient that the energy-saving assistance system has a switch-off possibility with which the vehicle driver can switch off the system when necessary.

During the automatic operation, the system is preferably configured in such a way that it can, when necessary, be overridden by the vehicle driver. Optical, acoustic or haptic feedback can additionally take place via the energy-saving measure or measures. The type of feedback can particularly preferably be selected by the driver.

According to a further preferred embodiment of the invention, a driver profile is established in a manner known per se, and the mode, in particular the method of the energy-saving measure is set automatically by the energy-saving assistance system in accordance with the established driver profile.

The data link of the mobile unit or the device via the additional data bus (further data channel) to the data bus of the vehicle is preferably not embodied as an initially fixed connection. That is to say it can either be easily set up once by the vehicle driver through retrofitting (and then no longer released without destruction) or is embodied in such a way that it can be disconnected as often as desired. In the case of a wire link, the connection can be made capacitively, inductively or galvanically, for example with a destruction-free line tap of the CAN bus which can be installed subsequently by the driver according to an inductive principle. Alternatively, the data link is particularly easily made via a radio interface, in particular by means of a WLAN (Wireless Local Area Network) radio interface.

Further preferred embodiments emerge from the following description of exemplary embodiments with reference to a figure and a table.

### BRIEF DESCRIPTION OF THE DRAWINGS

The invention is best understood from the following detailed description when read in connection with the accompanying drawings. Included in the drawings is the following figures:

FIG. 1 is a schematic illustration of an energy-saving assistant according to an example of the invention.

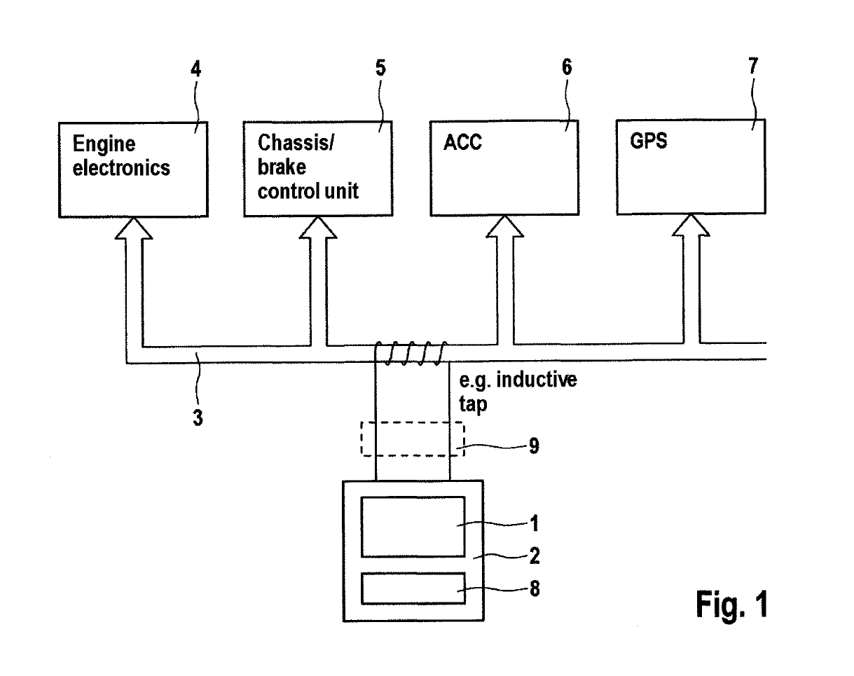

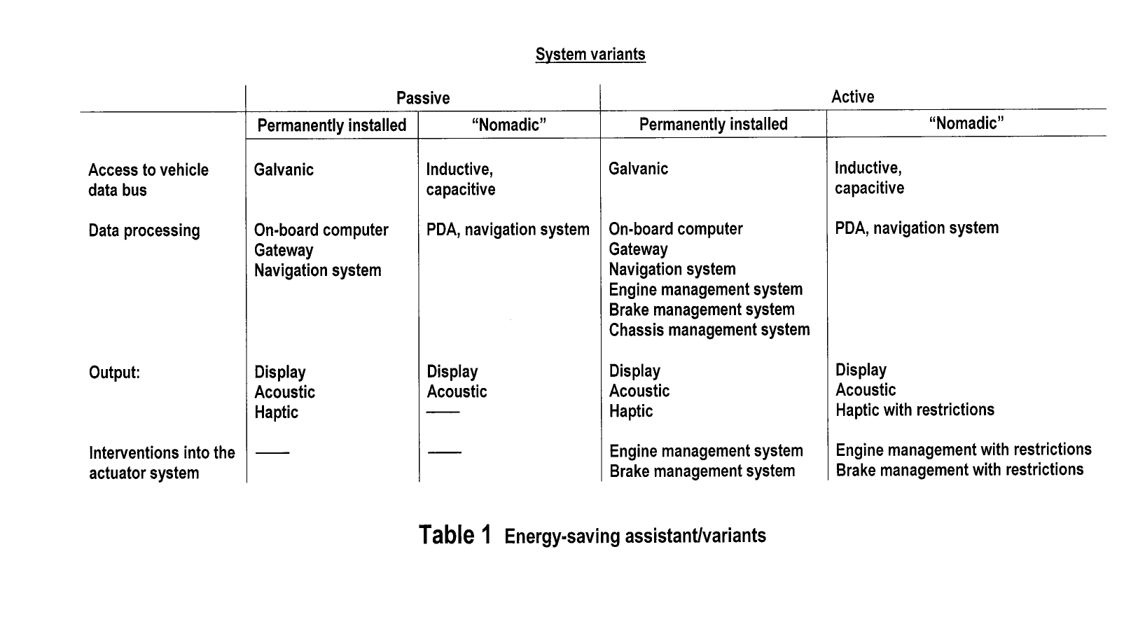

### DETAILED DESCRIPTION OF THE PREFERRED EMBODIMENTS

The outputting of the driver information which is calculated by the energy-saving algorithm 8 is done by means of a display 1 in the mobile computer 2. As well as or in addition to the visual display, the computer 2 can also output an acoustic signal. Haptic feedback in the form of a vibrating seat, steering wheel or in the form of vibrating pedals are also conceivable. The detailing of the display can either be a simple red/green display or detailed information, for example about the current consumption in I/100 km, as well as about the achievable potential in an optimum driving style. Displays which indicate that the vehicle is being driven in a way that particularly takes into account the environment are also conceivable.

The vehicle according to the illustrated example comprises an engine control unit 4, a brake/chassis control system 5, an adaptive cruise control system 6 and a navigation system 7. The vehicle control units which are mentioned above and, if appropriate, further control units for exchanging data or control commands are connected via the internal CAN bus 3.

A particular feature of the exemplary system is that the mobile computer 2 (“nomadic” variant in table 1) is coupled or can be coupled to the vehicle data bus 3 over an additional data channel 9 which can be subsequently installed in the vehicle. In this way an owner of a vehicle is able to retrofit the energy-saving system in a vehicle which was not originally equipped with an energy-saving system. According to one embodiment variant which is not illustrated, the additional data bus can also be provided by means of a WLAN radio link (for example in the GHz range, for example Bluetooth®).

According to one example (not illustrated), it is particularly expedient if the navigation system 7 and the energy-saving algorithm 8 are combined in a WLAN-enabled mobile telephone or PDA.

The possible variants of the energy-saving assistant according to the aspects of the invention are combined once more in table 1.

In the table, a distinction is made between the “passive” and “active” variants. The passive variant does not automatically make any interventions into the vehicle actuator system. The active variant is capable of intervening, for example, in the engine management system or the brake management system. Both “active” and “passive” variants can respectively be either “permanently installed” or embodied as a “nomadic” unit.

1.-9. (canceled)

10. A motor vehicle energy-saving assistance system which assists the driver in saving energy or in optimizing emissions, comprising:
an electronic device configured to implement an energy-saving algorithm and which exchanges data, over a further data channel, with a plurality of electronic vehicle control units which communicate over at least one data bus, wherein the plurality of vehicle control units carry out specific driver assistance or vehicle functions, and wherein the further data channel makes available a connection between the electronic device and one or more of the vehicle control units, wherein said connection permits at least a unidirectional transmission of data, and
at least one driver display device which is actuated by the energy-saving algorithm,
wherein, in order to establish an energy-saving measure or measures, the energy-saving algorithm determines the current state of the vehicle and the expected future state thereof.

11. The system as claimed in claim 10, wherein the further data channel facilitates wireless, inductive or capacitive transmission of data.

12. The system as claimed in claim 10, wherein the specific driver assistance or vehicle function or functions is/are one or more functions from the group of: engine control, vehicle control, brake control, anti-lock brake control, electronic stability control, adaptive cruise control, navigation system, satellite-supported determination of position, and cartographically supported navigation systems.

13. The system as claimed in claim 12, wherein the cartographically supported navigation system uses current map data from mobile radio networks.

14. The system as claimed in claim 10, wherein the electronic device and/or the at least one driver display device is/are embodied as a mobile device or mobile devices, wherein the mobile device or devices is/are galvanically, inductively or capacitively coupled to the data bus via the additional data bus in such a way that the mobile device or devices are easily connectable to the bus.

15. The system as claimed in claim 10, wherein said system performs at least one or more of energy-saving measures including intervention into the speed control of the vehicle by braking and/or accelerating.

16. The system as claimed in claim 10, wherein said system performs at least one or more of energy-saving measures including intervention into a vehicle operated pedal characteristic, a steering characteristic, and/or a braking characteristic.

17. The system as claimed in claim 10, wherein said system performs at least one or more of energy-saving measures including intervention into the distance to be set by an adaptive cruise controller and/or haptic/optical display of a proposed measure for the vehicle driver.

18. The system as claimed in claim 10, wherein the electronic device configured to implement the energy-saving algorithm which controls the system is embodied in a mobile computer.

19. The system as claimed in claim 18, wherein the mobile computer is coupled to the data bus.

20. The system as claimed in claim 12, wherein the brake controller comprises a recovery means for recovering braking power in an accumulator.

21. The system as claimed in claim 10, wherein the energy-saving measure or measures is/are optionally carried out independently.

22. The system as claimed in claim 10, wherein the energy-saving measure or measures is/are selected by the driver.

23. The system as claimed in claim 10, wherein the electronic device is permanently installed in the vehicle.

24. A motor vehicle, said motor vehicle equipped with an interface for an energy-saving assistance system, wherein said interface provides access to the vehicle-internal bus system by an energy-saving assistance system.

25. The motor vehicle as claimed in claim 24, wherein the interface is a radio interface.

26. The motor vehicle as claimed in claim 24, wherein the interface comprises a safety device which prevents non-enabled use of the interface.
